(19) United States
(12) Patent Application Publication
(10) Pub. No.: US 2017/0303151 A1
(43) Pub. Date: Oct. 19, 2017

(54) METHOD AND APPARATUS FOR DUAL CONNECTIVITY INTER-FREQUENCY MEASUREMENTS

(71) Applicant: Nokia Technologies Oy, Espoo (FI)

(72) Inventors: Petteri LUNDEN, Espoo (FI); Esa MALKAMÄKI, Espoo (FI); Elena VIRTEJ, Espoo (FI); Lars DALSGAARD, Oulu (FI); Niko KOLEHMAINEN, Espoo (FI)

(21) Appl. No.: 15/509,784

(22) PCT Filed: Sep. 22, 2015
(86) PCT No.: PCT/IB2015/057315

§ 371 Date: Mar. 8, 2017

Related U.S. Application Data
(60) Provisional application No. 62/056,472, filed on Sep. 26, 2014.

(51) Int. Cl. H04W 24/08; H04W 24/10; H04W 52/02; H04W 88/06

(52) U.S. Cl. CPC H04W 24/08; H04W 52/0212; H04W 24/10; H04W 88/06

(57) ABSTRACT

Various apparatae, methods and code are described for determining a designation or lack thereof of a carrier to at least one of a master cell group and a secondary cell group from at least one of at least one measurement object or at least one reporting configuration received from a network; determining measurement parameters for the carrier based on the designation or lack thereof from configurations and/or activities associated with the determined cell group; and performing measurements on the carrier corresponding to the determined measurement parameters. Various apparatae, methods and code are described for, in response to determining a user equipment's measurements being too infrequent on a carrier part of the user equipment's master cell group, assigning the carrier to the user equipments secondary cell group and receiving corresponding measurement reports.

### CROSS-REFERENCE TO RELATED APPLICATION

This application claims priority from U.S. Provisional Patent Application No. 62/056,472 filed Sep. 9, 2014, which is hereby incorporated in its entirety.

### TECHNICAL FIELD

The present application relates generally to configuration and performing of interfrequency measurements for dual connectivity.

### BACKGROUND

LTE-Advanced as being developed by 3rd Generation Partnership Project (3GPP) is currently being amended to allow the use of dual connectivity. That is, a capability is being developed whereby a user equipment (UE) may consume radio resources provided by at least two different network points termed master enhanced node B (MeNB) and secondary enhanced node B (SeNB). A MeNB is characterized as a base station (eNB) that acts as mobility anchor for the UE towards a core network (CN) whereas a SeNB is characterized as an eNB which provides additional resources for the UE, but is not a MeNB.

As each of the MeNB and SeNB may employ carrier aggregation, each of the MeNB and SeNB may comprise a plurality of cells to facilitate the carrier aggregation. In general, for carrier aggregation of the MeNB, a group of serving cells is associated with the MeNB, comprising a primary cell (PCell) and one or more secondary cells (SCells). This group may be referred to as a master cell group (MCG). For carrier aggregation of the SeNB, a group of serving cells is associated with the SeNB, comprising a primary cell (PSCell) and one or more secondary cells (SCells). This group may be referred to as a secondary cell group (SCG). In the SeNB, the PSCell carries the physical uplink control channel (PUCCH) for the SCG.

As there are no limitations as to which carrier a cell is operating on, the cells in the MCG and SCG may be operating on different carriers, including carriers on different bands.

A further characterization of dual connectivity is that each of the MCG and SCG are handled by different medium access control (MAC) entities.

### SUMMARY OF THE INVENTION

Various aspects of examples of the invention are set out in the claims.

According to a first aspect of the present invention, an apparatus, method or code for determining a designation of a carrier to at least one of a master cell group and a secondary cell group from at least one of at least one measurement object or at least one reporting configuration received from a network; determining measurement parameters for the carrier based on the designation from at least one of a DRX configuration and activity associated with the determined cell group; and performing measurements on the carrier corresponding to the determined measurement parameters.

According to a second aspect of the present invention, an apparatus, method or code for determining a lack of a designation of a carrier to one of at least a master cell group and a secondary cell group from at least one of at least one measurement object and at least one reporting configuration received from a network; determining measurement parameters for the carrier corresponding to a strictest parameter of at least one selected from a DRX configuration and activity associated with the master cell group and at least one selected from a DRX configuration and activity associated with the secondary cell group; and performing measurements on the carrier corresponding to the determined measurement parameters.

According to a third aspect of the present invention, an apparatus, method or code for determining a designation of a carrier to one of a master cell group and a secondary cell group from at least one of at least one measurement object and at least one reporting configuration received from a network; if the designation of the carrier is determined to be to the secondary cell group, determining measurement parameters for the carrier corresponding to at least one of a DRX configuration and activity associated with the determined secondary cell group and performing measurements on the carrier in accordance with the determined measurement parameters; and if the designation of the carrier is determined to be to the primary cell group, performing measurements on the carrier corresponding to measurement parameters associated with DRX not being configured on the primary cell group, regardless of whether DRX is configured on the primary cell group.

According to a fourth aspect of the present invention, an apparatus, method or code for determining that measurements at a user equipment on a carrier part of the user equipment's master cell group are too infrequent; in response to the determining, indicating to the user equipment a designation of the carrier as also being part of the user equipment's secondary cell group; and one of: receiving), from the user equipment, a measurement report of the carrier in accordance with measurement parameters according to the secondary cell group; receiving, from the user equipment, a measurement report of the carrier in accordance with a strictest of the measurement parameters according to the secondary cell group and the measurement parameters according to the master cell group; or receiving, from the user equipment, a measurement report of the carrier comprising an indication indicating at least whether measurement parameters used in performing measurements associated with the measurement report were associated with the user equipment's master cell group or with the user equipment's secondary cell group.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example dual connectivity wireless system;

FIG. 2 illustrates an example measurement configuration;

FIG. 3 illustrates an example measurement configuration;

FIG. 4 illustrates an example reporting configuration;

FIG. 5 illustrates an example wireless apparatus in accordance with an example embodiment of the invention; and

FIG. 6 illustrates an example flow diagram according to embodiments of the invention.

FIG. 7 illustrates an example flow diagram according to embodiments of the invention.

FIG. 8 illustrates an example flow diagram according to embodiments of the invention.

FIG. 9 illustrates an example flow diagram according to embodiments of the invention.

### DETAILED DESCRIPTION

As MCG and SCG are handled through different MAC entities, for example example traffic characteristics and discontinuous transmission (DRX) characteristics of the MCG and SCG may substantially differ. For example, when the SCG is designated for an offloading purpose, the SCG may have low activity for the UE and have a DRX with large gaps configured. At the same time, the MCG may have high activity and have a DRX with short gaps configured, or may have no gaps configured at all. In some scenarios, the UE may not have any activity at all on either the MCG or SCG.

In order to for example balance power consumption due to measurement activity with the need for sufficiently accurate and timely measurement information to facilitate mobility, it is desirable to adapt measurement of carriers to the UEs activity and/or DRX configuration. Parameters by which measurements may be adapted are for example timing for detection of cells, identification of detected cells, measurement duration, radio link monitoring related evaluation periods, etc. These parameters may hence be adapted based on the UEs activity and/or DRX configuration.

However, for example for inter-frequency carriers, a UE may not be aware of whether cells on the carrier should be associated with the MCG or SCG as the UE may not have an existing serving cell in its configured MCG and SCG on the carrier. Hence, it may not be able to determine which DRX and/or activity should be considered for the configuration of the measurement on the inter-frequency carrier.

It may be noted that as the designation of a cell or carrier as belonging to MCG or SCG is a function of the service the cell is intended to provide to a specific UE. A cell or carrier may for example belong the MCG of one UE, but to the SCG of another. And similarly, a cell or carrier may in time transition from MCG to SCG and vice versa for a specific UE. It may hence not be determined from measurement of a broadcast characteristic of a cell whether it is intended to be comprised in the MCG or SCG of a UE.

In one embodiment of the present invention, an eNB determines for a UE a division of at least one (interfrequency) carrier into a group of carriers that belong to the MCG and a group of carriers that belong to the SCG. That is, the eNB designates the carriers as being candidates to serve as PCell or Scell in the UE's MCG or as candidates to serve as PSCell or Scell in the UE's SCG. The eNB then informs the UE of the MCG/SCG designation of at least one (interfrequency) carrier for the purpose of measurement. For example, the eNB may configure the UE with a new measurement object for the at least one (interfrequency) carrier which indicates the designation.

In one embodiment of the present invention, a UE may receive an MCG/SCG designation of at least one (interfrequency) carrier for the purpose of measurement. For example, a UE may receive a configuration for a new measurement object for the at least one (interfrequency) carrier which indicates the designation.

In some embodiments of the presention invention, a UE measures the configured measurement objects indicated to be candidates for its MCG according to the DRX and/or activity of the MCG and measures the configured measurement objects indicated to be candidates for its SCG according to the DRX and/or activity of the SCG.

The UE may, when it is actively scheduled on the MCG, for example when a DRX inactivity timer is running for the MCG, measure the configured measurement objects indicated to be MCG candidates according to non-DRX activity, for example when the UE is not configured with DRX in the MCG.

Similarly, the UE may, when it is actively scheduled on the SCG, for example when a DRX inactivity timer is running for the SCG, measure the configured measurement objects indicated to be SCG candidates according to non-DRX activity, for example when the UE is not configured with DRX in the SCG.

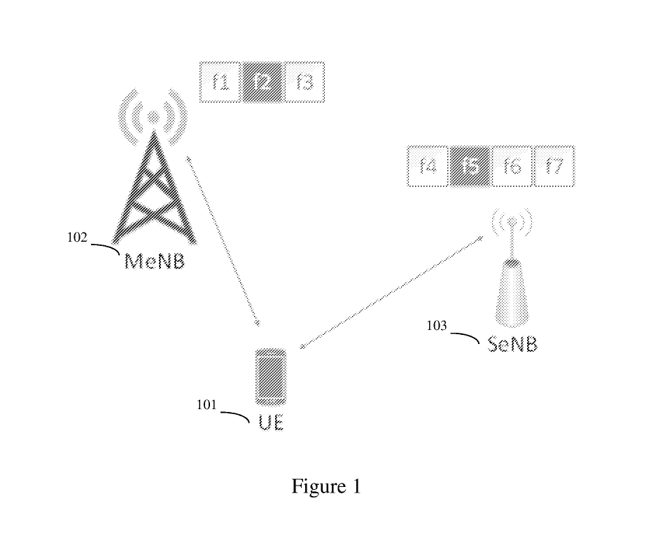

In an example dual connectivity network according to FIG. 1, a UE (101) is configured with a MeNB (102) and a SeNB (103), where it is currently served by a cell associated with the MeNB on carrier f2 and a cell associated with the SeNB on carrier f5. For simplicity of the example, no SCells are depicted to serve the UE for either the MeNB or SeNB. In an example according to the current invention, the MeNB on f2 and/or the SeNB on f5 may configure the UE with one or more measurement objects for the measurement of interfrequency carriers f1, f3, f4, f6 and f7, wherein the measurement objects designates whether a carrier to be measured is to be considered a candidate for the MCG or for the SCG. As depicted, f1 and f3 are designated candidates for the MCG and f4, f6 and f7 are designated candidates for the SCG. In some embodiments, f1, f2 and f3 may be in one frequency band and f4, f5, f6, f7 in another frequency band. The set of channels f1-f7 may however be any set of channels available to the network and no bandsplit or channel-adjacancy requirement is intended in the depiction.

In accordance with embodiments of the invention, the UE (101), would proceed with measurement of channels f1, f3, f4, f6 and f7 in accordance with the configured at least one measurement object and measure channels f1 and f3 according to the DRX and/or activity of the MCG and measure channels f4, f5 and f7 according to the DRX and/or activity of the SCG.

In an embodiment according the invention, an eNB may designate a carrier by explicitly signaling its designation, for example in a measurement object. The signaling of the cell group designation may take the form of a binary indication. In the context of LTE-A, this may for example take the following form:

$$\begin{matrix}MeasObjectEUTRA \text{::} = & SEQUENCE \{ & & \\ carrierFreq & ARFCN \text{-} ValueEUTRA , & & \\ … & & & \\ [ [ cellGroup & ENUMERATED \{ \begin{matrix}MCG , \\ SCG\end{matrix} \} & OPTIONAL & \text{--} Need \\ ON & & & \\ ] ] & & & \\ \} & & & \end{matrix}$$

In some embodiments, while in dual connectivity, the absence of the cellGroup indicator may imply that the UE should apply the strictest measurement configuration of the measurement configuration according to the MCG DRX and/or activity and the SCG DRX and/or activity. In yet an alternate embodiment, the cellGroup may allow for al least an additional value that explicitly indicates to use the strictest configuration, for example {MCG, SCG, Strictest}

In another embodiment, an eNB may designate a carrier by implicitly signaling its designation. For example, an eNB may designate a carrier to be a candidate for SCG by configuring a measurement event to relate to a PSCell quality or to relate to a carrier where a SCG serving cell is operating. This may in some embodiments be achieved by signaling a reporting configuration which cell's quality (for example reference signal received power (RSRP) or reference signal received quality (RSRQ)) is used as a reference. For example the PCell or PSCell quality could be signaled as being the reference.

In the context of LTE-A, reporting configurations (measurement events) A3 and A5 have been defined. In accordance with an embodiment of the present invention, these events may be modified to include an indication of whether the event is in reference to a PCell or PSCell. In accordance with another embodiment of the present invention, the present events A3 and A5 may be limited for events in the PCell (or MCG) and new events, for example A7 and A8, may be defined which substantially correspond to events A3 and A5, but are limited for events in the PSCell (or SCG). Naturally combinations of these two approaches may also be envisioned.

In the aforementioned embodiments, there is no need for explicit indication of a MCG/SCG designation in a measurement object, as a UE may infer the designation from at least one reporting configuration linked to a measurement object. Such a UE may hence proceed with measurement of an (interfrequency) carrier in accordance with the DRX and/or activity as inferred from the at least one reporting configurations linked to a measurement object.

It is envisioned that reporting configurations for a measurement object may conflict. For example, both PCell and PSCell reporting configurations may be linked to a measurement object for a carrier. For such cases, a UE measure a carrier according to the strictest of the measurement requirements corresponding to the MCG and SCG DRX and/or activity. Strict in this context may be interpreted as requiring the most frequent measurement. For example, if DRX is configured for the MCG and no DRX is configured for SCG, the UE measures the carrier according to the stricter SCG configuration. In another embodiment where such conflict occurs, the UE may be configured to always measure according to the MCG DRX and/or activity.

In yet another embodiment, where a UE receives a designation of a carrier as being for MCG, the UE may always apply measurements as if the MCG does not have DRX configured, regardless of whether it is enabled at the time of measurement.

In yet another embodiment, a UE receives no designation whether an interfrequency carrier measurement is for MCG or SCG, the UE may always apply measurements as if the carrier would not have DRX configured.

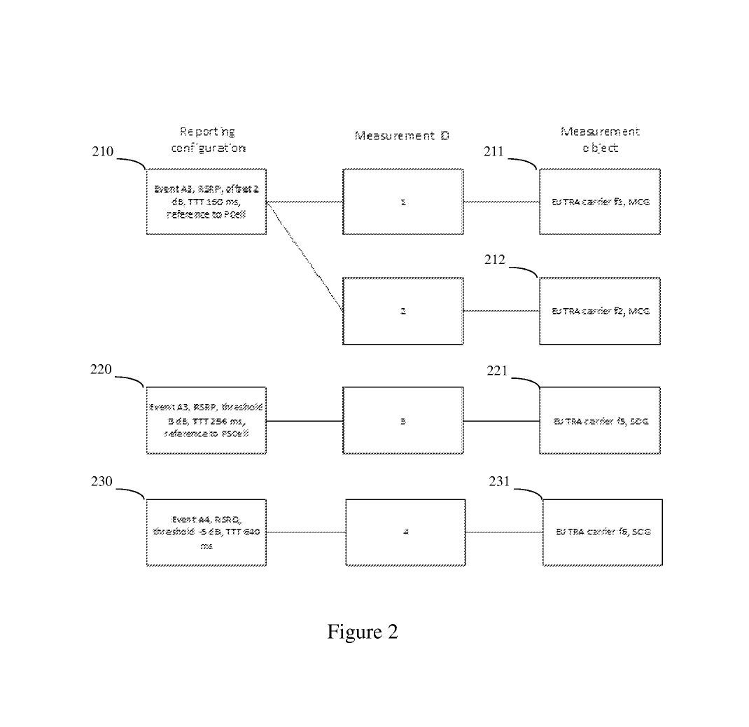

FIG. 2 depicts, in reference to FIG. 1, an example reporting configuration corresponding to aspects of the present invention. As depicted in FIG. 1, a UE has a PCell configured on f2 and a PSCell configured on f5. In FIG. 2, measurement objects and reporting configurations are defined accordingly (210, 212, 220, 221). Carriers f1 and f6 are interfrequency carriers. Configuration for carriers f3 and f4 is not shown for brevity. A UE configured as depicted, in accordance with the current invention, would retrieve the designation of f1 as being a MCG candidate either from the reporting configuration, which indicates event A3 to reference the PCell and/or from the measurement object (210) which designates MCG. In addition, the UE would retrieve the designation of f6 as being for SCG from the measurement object (231), but not from event (230), as in this particular example, no MCG/SCG indication can be inferred from this reporting configuration.

Because carriers f2 and f5 are configured as intrafrequency carriers and belong to the UE's MCG and SCG respectively, explicit indication through measurement objects or implicitly through linked reporting is not necessary. Should the indications be present and conflict with the actual allocation of these carriers to MCG and SCG respectively, then the UE may choose or be configured to follow the indications or ignore them.

A UE may for example choose or be configured to selectively follow conflicting indications. For example in a scenario where the MCG is not scheduled and the SCG is scheduled, measurement according to MCG DRX and/or activity parameters may result in infrequent measurement, which increases the chance of losing the connection. In a single connection scenario this is generally acceptable as the lack of scheduled traffic doesn't make reconnection delay problematic. However, in dual connectivity, the loss of MCG connection results in loss of the SCG connection as the SCG connection is tied to the MCG connection. Therefore, loss of the MCG connection would disrupt activity on the SCG. In accordance with an embodiment of the present invention, an eNB may hence explicitly or implicitly designate a carrier currently part of the UE's MCG as SCG, for example to reduce the probability of connection loss. A UE may hence follow such a conflicting designation in performing the corresponding measurements.

Similarly, scenarios may be envisioned where the network wishes to transfer a carrier currently being part of a UE's MCG to the UE's SCG (or vice versa currently being part of a UE's SCG to the UE's MCG) and provides a designation conflicting with the current MCG or SCG to initiate measurements to support the transfer. A UE may hence follow such a conflicting designation in performing the corresponding measurements.

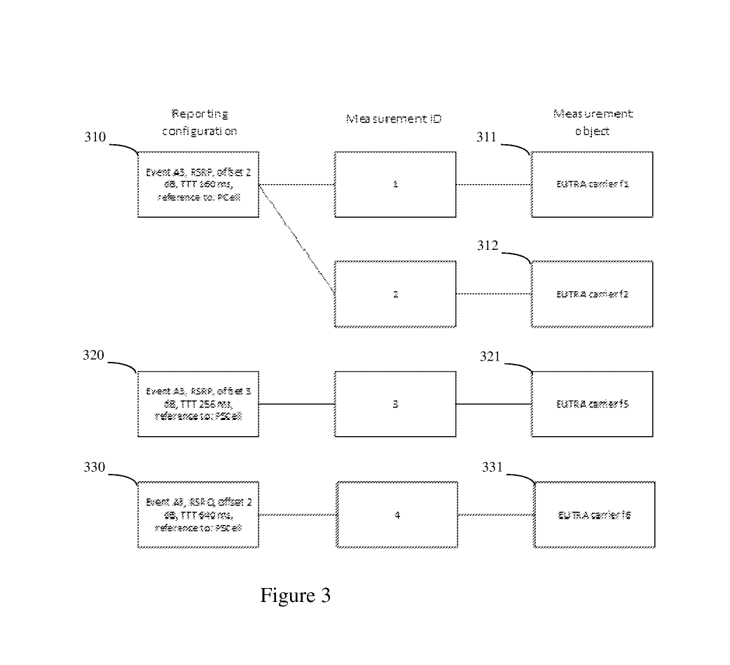

FIG. 3 depicts, in reference to FIG. 1, an example reporting configuration corresponding to aspects of the present invention. As depicted in FIG. 1, a UE has a PCell configured on carrier f2 and a PSCell configured on carrier f5. In FIG. 3, the measurement configurations (311, 331) do not explicitly designate whether the carrier is a candidate and hence should be measured according to the DRX and/or activity of the MCG or SCG. In this case, the UE infers the designation from the reporting configurations (310, 330) linked to the measurement objectives. In this example, the event A3 indicates whether the event is in reference to the PCell (associated with the MCG), for example for carrier f1, or the PSCell (associated with the SCG), for example for carrier f6.

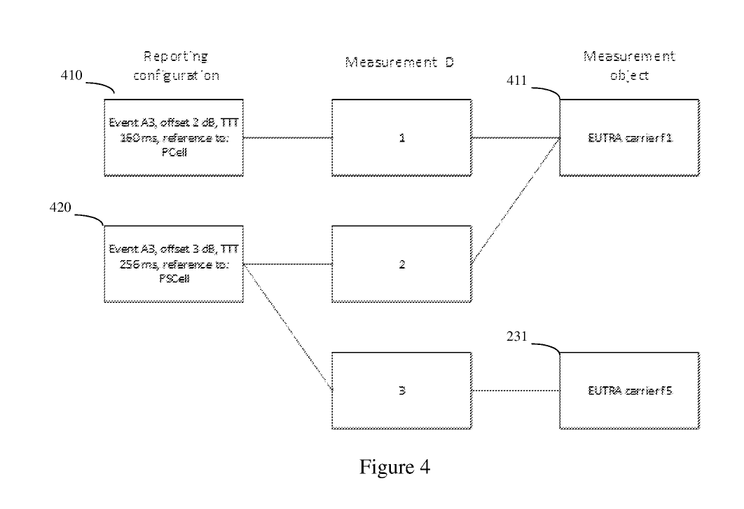

FIG. 4 depicts, in reference to FIG. 1, an example reporting configuration corresponding to aspects of the present invention. As depicted in FIG. 1, a UE has a PCell configured on carrier f2 and a PSCell configured on carrier f5. In FIG. 4, only the configuration relating to carrier f1 and carrier f5 are shown for illustration. In this example, the UE infers from reporting configuration (420), consistent with the allocation of f5 to the SCG, that f5 should be measured according to the DRX and/or activity of the SCG. However, a conflict occurs for carrier f1, because it is in this example associated with measurement events (reporting configurations) for both PCell (410) and PSCell (420). In this case, the UE may apply measurements according to the strictest of the MCG DRX and/or activity and SCG DRX and/or activity.

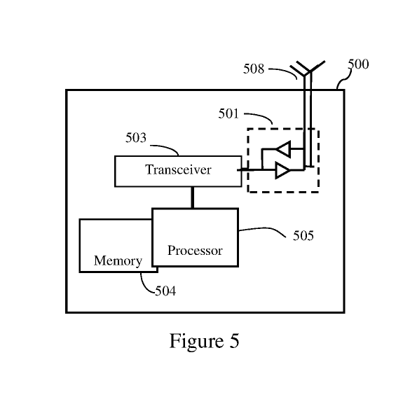

FIG. 5 depicts a block diagram illustrating an example wireless apparatus (500) in accordance with an example embodiment of the invention. The wireless apparatus (500) may include a processor (505), a memory (504) coupled to the processor (505) and at least one suitable transceiver (503) having a transmitter and a receiver coupled to the processor (505), coupled to at least one antenna unit (508) through at least one amplifier (501). The memory (504) may store computer programs, which may, when executed by the processor (505), for example in combination with any of the at least one transceiver (503), at least one amplifier (501) and at least one antenna unit (508), perform embodiments of the invention as described in the present application.

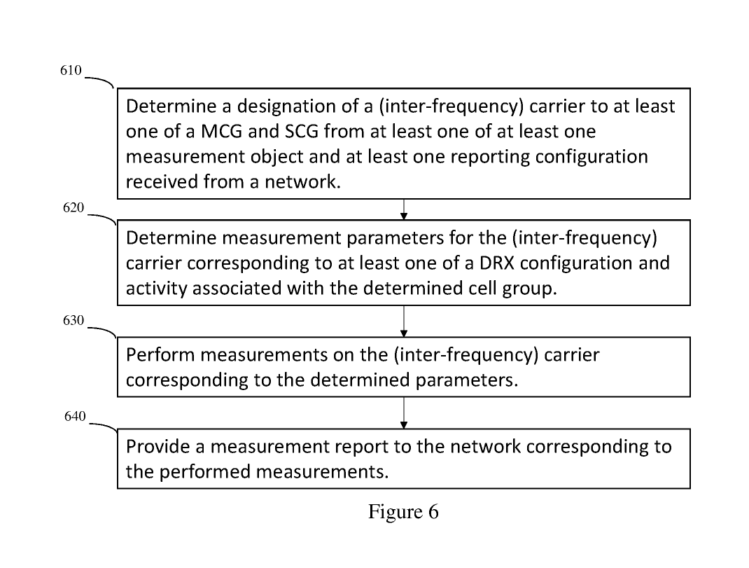

FIG. 6 depicts a flow diagram according to embodiments of the present invention. At block (610) a UE determines a designation of a (inter-frequency) carrier to at least one of a MCG and SCG from at least one of at least one measurement object and at least one reporting configuration received from a network. At block (620), the UE determines measurement parameters for the (inter-frequency) carrier corresponding to at least one of a DRX configuration and activity associated with the determined cell group. At block (630), the UE perform measurements on the (inter-frequency) carrier corresponding to the determined parameters and at block (640), the UE provides a measurement report to the network in accordance with the performed measurements.

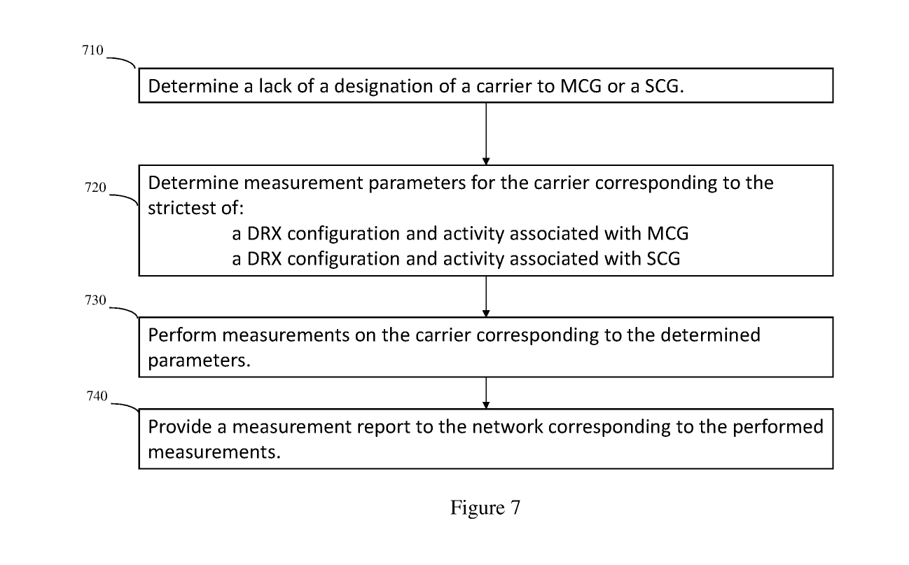

FIG. 7 depicts a flow diagram according to embodiments of the present invention. A UE determines (710) a lack of a designation of a carrier to one of at least a master cell group and a secondary cell group from at least one of at least one measurement object and at least one reporting configuration received from a network; In response, the UE then determines (720) measurement parameters for the carrier corresponding to a strictest parameter of at least one selected from a DRX configuration and activity associated with the master cell group and at least one selected from a DRX configuration and activity associated with the secondary cell group and performs (730) measurements on the carrier corresponding to the determined measurement parameters. Subsequently, the UE may provide (740) a measurement report to the network in accordance with the performed measurements.

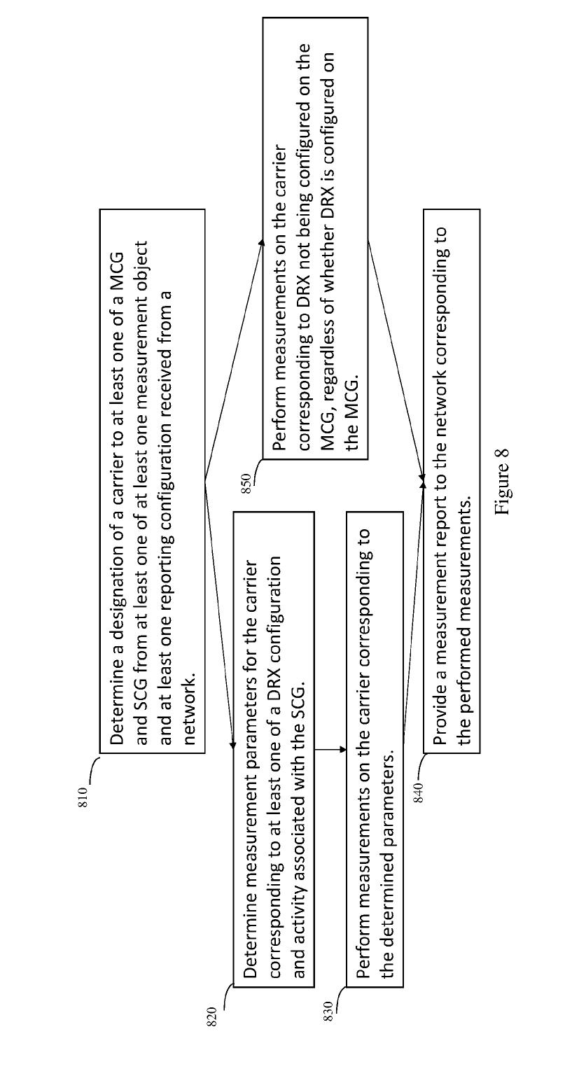

FIG. 8 depicts a flow diagram according to embodiments of the present invention. A UE determines (810) a designation of a carrier to one of a master cell group and a secondary cell group from at least one of at least one measurement object and at least one reporting configuration received from a network. If the designation of the carrier is determined to be to the secondary cell group, then the UE determines (820) measurement parameters for the carrier corresponding to at least one of a DRX configuration and activity associated with the determined secondary cell group and perform (830) measurements on the carrier in accordance with the determined measurement parameters. Otherwise, if the designation of the carrier is determined to be to the primary cell group, then the UE performs (850) measurements on the carrier corresponding to measurement parameters associated with DRX not being configured on the primary cell group, regardless of whether DRX is configured on the primary cell group. Subsequently, the UE may provide (840) a measurement report to the network in accordance with the performed measurements.

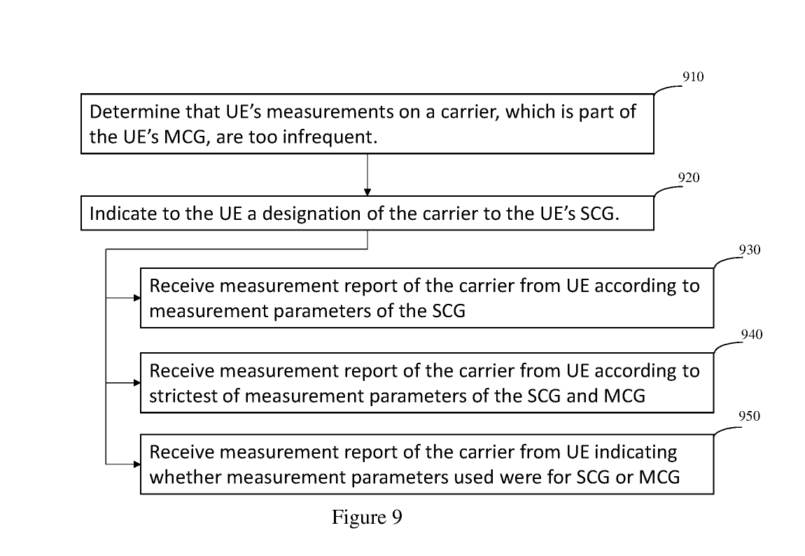

FIG. 9 depicts a flow diagram according to embodiments of the present invention. An eNB determines (910) that measurements at a user equipment on a carrier part of the user equipment's master cell group are too infrequent. In response, the eNB indicates (920) to the user equipment a designation of the carrier as also being part of the user equipment's secondary cell group. The eNB may in some embodiments receive (930), from the user equipment, a measurement report of the carrier in accordance with measurement parameters according to the secondary cell group. The eNB may in some embodiments receive (940), from the user equipment, a measurement report of the carrier in accordance with a strictest of the measurement parameters according to the secondary cell group and the measurement parameters according to the master cell group. The eNB may in some embodiments receive (950), from the user equipment, a measurement report of the carrier comprising an indication indicating at least whether measurement parameters used in performing measurements associated with the measurement report were associated with the user equipment's master cell group or with the user equipment's secondary cell group.

In at least some embodiments according to the invention, a UE providing a measurement report may indicate whether the measurement has been performed according to measurement parameters consistent with the MCG or SCG DRX and/or activity. In the absence of such an explicit indication, an eNB may assume the measurements have been performed consistent with at least one of explicit indications in measurement objects provided by the network to the UE or implicit indications in reporting configurations provided by the network to the UE, for example also including any mutually understood conflict resolution handling as generally disclosed herein.

Embodiments of the present invention may be implemented in software, hardware or a combination thereof. The software and/or hardware may reside on chips comprising for example dedicated circuits or DSPs. In an example embodiment, the software or an instruction set is maintained on any one of various conventional computer-readable media. In the present disclosure, a “computer-readable medium” may be any non-transitory media or means that can contain, store, communicate, propagate or transport the instructions for use by or in connection with an instruction execution system, apparatus, or device, such as a computer. A computer-readable medium may comprise a computer-readable storage medium that may be any non-transitory media or means that can contain or store the instructions for use by or in connection with an instruction execution system, apparatus, or device, such as a computer.

It is also noted herein that while the above describes example embodiments of the invention, these descriptions should not be viewed in a limiting sense. Rather, there are several variations and modifications which may be made without departing from the scope of the present invention as defined in the appended claims While embodiments of the invention are described with examples relating to LTE-A, the invention may be applied to other communication systems applying scheduling requests or messages similar to scheduling requests without departing from the scope of the present invention.

Although various aspects of the invention are set out in combination, other aspects of the invention comprise other combinations of features from the described embodiments. The invention is hence not limited solely to combinations explicitly set out.

While embodiments of the invention are described with examples relating to LTE-A, the invention may be applied to other communication systems.

3GPP TS36.133 v 12.4.0, entitled “Evolved Universal Terrestrial Radio Access (E-UTRA); Requirements for support of radio resource management” is hereby incorporated in its entirety.

3GPP TS36.331 v 12.3.0, entitled “Evolved Universal Terrestrial Radio Access (E-UTRA); Radio Resource Control (RRC); Protocol specification” is hereby incorporated in its entirety.

1. An apparatus, comprising:
at least one processor; and
at least one memory including computer program code
the at least one memory and the computer program code configured to, with the at least one processor, cause the apparatus to perform at least the following:
determine a designation of a carrier to at least one of a master cell group and a secondary cell group from at least one of at least one measurement object or at least one reporting configuration received from a network;
determine measurement parameters for the carrier based on the designation from at least one of a discontinuous transmission (DRX) configuration and activity associated with the determined cell group; and
perform measurements on the carrier corresponding to the determined measurement parameters.

2. The apparatus of claim 1, wherein the determining the designation further comprises determine the measurement designation of the carrier to one of the master cell group, the secondary cell group and a strictest of the master cell group and the secondary cell group from at least one of at least one measurement object and at least one reporting configuration received from a network.

3. The apparatus of claim 1, wherein the at least one of at least one measurement object and at least one reporting configuration received from a network comprises a parameter capable of indicating at least a value indicative of the master cell group, a value indicative of the secondary cell group and a value indicative of a strictest of the master cell group and the secondary cell group.

4. The apparatus of claim 1, wherein the at least one memory and the computer program code further configured to, with the at least one processor, cause the apparatus to perform at least the following:
determine the existence of a conflict by determining that at least one measurement object is linked to at least one reporting configuration indicating a primary cell of the master cell group and to at least one reporting configuration indicating a primary cell of the secondary cell group; and
in response to determination of the existence of the conflict, determine the designation of the carrier to be a designation to the cell group corresponding to a strictest parameter of at least one selected from a DRX configuration and activity associated with the master cell group and at least one selected from a DRX configuration and activity associated with the secondary cell group.

5. The apparatus of claim 2, where strictness is determined according to a measurement frequency.

6. The apparatus of claim 1, wherein the at least one memory and the computer program code further configured to, with the at least one processor, cause the apparatus to perform at least the following:
determine the existence of a conflict by determining that at least one measurement object is linked to at least one reporting configuration indicating a primary cell of the master cell group and to at least one reporting configuration indicating a primary cell of the secondary cell group; and
in response to the determination of the existence of the conflict determine the designation of the carrier to be a designation to the master cell group.

7. The apparatus of claim 1, wherein the designation is derived from a reference quality value being associated with a primary cell of the master cell group (PCell) or being associated with a primary cell of the secondary cell group (PSCell).

8. The apparatus of claim 1, wherein the designation is derived from a reporting configuration configured to relate to a quality of one of a primary cell of the master cell group (PCell) and a primary cell of the secondary cell group (PSCell).

9. The apparatus of claim 7, wherein the quality is one of a reference signal received power and a reference signal received quality.

10. The apparatus of claim 1, wherein the designation is derived from a reporting configuration configured to relate to a second carrier of one of a primary cell of the master cell group (PCell) and a primary cell of the secondary cell group (PSCell).

11. The apparatus of claim 1, wherein the designation is derived from a reporting configuration, wherein the type of the reporting configuration indicates whether a measurement event is in reference to a primary cell of the master cell group (PCell) or a primary cell of the secondary cell group (PSCell).

12. An apparatus, comprising:
at least one processor; and
at least one memory including computer program code the at least one memory and the computer program code configured to, with the at least one processor, cause the apparatus to perform at least the following:
determine a lack of a designation of a carrier to one of at least a master cell group and a secondary cell group from at least one of at least one measurement object or at least one reporting configuration received from a network;
determine measurement parameters for the carrier corresponding to a strictest parameter of at least one selected from a discontinuous transmission (DRX) configuration and activity associated with the master cell group and at least one selected from a DRX configuration and activity associated with the secondary cell group;
perform measurements on the carrier corresponding to the determined measurement parameters.

13. The apparatus according to claim 12, where strictness is determined according to a measurement frequency.

14. An apparatus, comprising:
at least one processor; and
at least one memory including computer program code
the at least one memory and the computer program code configured to, with the at least one processor, cause the apparatus to perform at least the following:
determine a designation of a carrier to one of a master cell group and a secondary cell group from at least one of at least one measurement object or at least one reporting configuration received from a network;
if the designation of the carrier is determined to be to the secondary cell group, determine measurement parameters for the carrier corresponding to at least one of a discontinuous transmission (DRX) configuration and activity associated with the determined secondary cell group and perform measurements on the carrier in accordance with the determined measurement parameters; and
if the designation of the carrier is determined to be to the master cell group,
perform measurements on the carrier corresponding to measurement parameters associated with DRX not being configured on the master cell group, regardless of whether DRX is configured on the master cell group.

15. The apparatus of claim 14, wherein the apparatus does not have a serving cell on the carrier.

16. The apparatus of claim 14, wherein the carrier is an interfrequency carrier.

17. The apparatus of claim 14, wherein the at least one memory and the computer program code further configured to, with the at least one processor, cause the apparatus to perform at least the following:
provide a measurement report to the network corresponding to the performed measurements.

18. The apparatus of claim 17, wherein providing the measurement report to the network comprises providing an indication capable of indicating at least whether the measurement parameters used in performing the measurements associated with the measurement report were associated with the master cell group or with the secondary cell group.

19.-40. (canceled)

41. The apparatus of claim 1, wherein the apparatus does not have a serving cell on the carrier.

42. The apparatus of claim 12, wherein the apparatus does not have a serving cell on the carrier.
